(19) United States
(12) Patent Application Publication
(10) Pub. No.: US 2007/0164846 A1
(43) Pub. Date: Jul. 19, 2007

(54) Interactive knowledge card system

(76) Inventor: Richard J. Pedolsky, Stockholm (SE)

Correspondence Address: BLANK ROME LLP, 600 NEW HAMPSHIRE AVENUE, N.W., WASHINGTON, DC, 20037, US

(21) Appl. No.: 11/639,435

(22) Filed: Dec. 15, 2006

Related U.S. Application Data
(60) Provisional application No. 60/750,823, filed on Dec. 16, 2005.

(51) Int. Cl. G05B 19/00

(52) U.S. Cl. 340/5.2; 340/10.42; 340/10.52; 340/5.81

(57) ABSTRACT

An interactive knowledge card system. The interactive knowledge card system having a card with user identification, several card stations, a server, and a database. Each card station has a station identifier and a user identification reader to read the user identification on the card. The server is in communication with the card stations and receives the read user identification and the station identifier from the user identification reader. The server associates the read user identification with the received station identifier. The database is in communication with the server. The database stores exhibit information associated with each station identifier and stores the read user identification and associated station identifier. The server is accessible by the user. The server retrieves the exhibit information associated with each station identifier associated with the user identification and displays the retrieved exhibit information.

### RELATED APPLICATION

This application claims priority to provisional application Ser. No. 60/750,823, filed Dec. 16, 2005, the disclosure of which is incorporated herein by reference in its entirety.

### BACKGROUND OF THE INVENTION

1. Field of the Invention

The present invention relates to an interactive system for providing information. In particular, the present invention relates to an interactive system for providing individualized information.

2. Background of the Related Art

Venues that attempt to impart knowledge to visitors, such as museums, historical sites, or conferences, must often provide explanatory material to give context to an exhibit. To convey further information about an exhibit, venues often employ devices such as display panels, brochures, audio equipment, and/or video equipment. Panels provide a space for written, pictorial, or graphical information. Brochures also provide a medium for supplemental written, pictorial, or graphical information. Audio and video equipment allow information to be presented beyond mere text and static pictures.

However, these devices are limited in how much information can be provided to visitors. The panel and brochure have limited space for all the potential information that can be presented. Audio and video presentations have time constraints. Further, these devices provide information in only one direction from the venue to a venue visitor. The venue visitor cannot obtain more information from a mere panel, brochure, audio explanation, or video presentation. Likewise, these devices are non-interactive. The venue visitor cannot tailor the contents of these devices to provide the information the visitor wants in a form the visitor desires. Constructivist learning theory holds that people learn best when they can build their acquisition of knowledge upon that which interests them so that interactive devices would enhance the venue's ability to impart knowledge to visitors. Similarly, the limited presentation of information will unlikely satisfy a wide and varied audience full of visitors with different levels of interests. Also, devices such as panels, brochures, audio explanations, and video presentations cannot furnish information about the visitors' behavior and interests which can be used for planning, visitor services, fundraising, and other key organizational support functions. Finally, these devices offer limited opportunity to generate additional revenue.

Venues may also utilize a website to provide more information to visitors after their visit to the venue. However, studies of post-visit web-site usage and behavior show that it is difficult to get visitors to connect to a venue's website after a visit. There are a number of obstacles including visitors forgetting the URL address to the site, visitors disliking to input the URL address, visitors losing interest as time passes, and visitors simply forgetting.

### SUMMARY OF THE INVENTION

Accordingly, it is an object of the invention to provide an interactive knowledge card system that provides each visitor with individualized information according to each visitor's interest even after visitors have left the site. It is a further object of the invention to provide a visitor relations management tool. It is still a further object of the invention to provide a revenue generator.

An exemplary embodiment of the present invention provides an interactive knowledge card system that includes a card with user identification, several card stations, a server, and a database. Each card station has a station identifier and a user identification reader to read the user identification on the card. The server is in communication with the card stations and receives the read user identification and the station identifier from the user identification reader. The server associates the read user identification with the received station identifier. The database is in communication with the server. The database stores exhibit information associated with each station identifier and stores the read user identification and associated station identifier. The server is accessible by the user. The server retrieves the exhibit information associated with each station identifier associated with the user identification and displays the retrieved exhibit information.

Another embodiment of the present invention provides an interactive knowledge card system for use at a location having multiple areas and each area is associated with information. The system includes an area identifier for each area, a mobile telephone with a mobile telephone number, a server, and a database. The server receives the mobile telephone number and the area identifier from the mobile telephone. The server associates the mobile telephone number with the area identifier. The database is in communication with the server. The database stores exhibit information associated with each area identifier and stores the mobile telephone number and associated area identifier. The server is accessible by the user. The server retrieves the exhibit information associated with each area identifier associated with the mobile telephone number and displays the retrieved exhibit information.

Yet another embodiment of the present invention provides a method for providing interactive and individualized information. The first step is to provide a user with a card having an user identification. Then several card stations are placed throughout a location with each card station having a user identification reader to read the user identification on the card. Next, a station identifier is assigned for each card station. After that, a server is placed in communication with the card stations. Then, exhibit information associated with each station identifier is stored on at least one database which is in communication with the server. User identification information and station identifier of the user identification reader that read the user identification is next stored on the database. After that, the user identification is correlated with the exhibit information associated with the station identifier of the user identification reader that read the user identification. Finally, the exhibit information associated with each station identifier whose user identification reader that read the user identification is provided.

These and other objects of the invention, as well as many of the intended advantages thereof, will become more readily apparent when reference is made to the following description, taken in conjunction with the accompanying drawings.

### BRIEF DESCRIPTION OF THE FIGURES

FIG. 1 is a semi-schematic block diagram of an interactive knowledge card system in accordance with a preferred embodiment of the invention.

FIG. 2 shows a knowledge card for the interactive knowledge card system.

FIG. 3 is a plan view of a knowledge card station for the interactive knowledge card system.

FIG. 4 is a plan view with a partial sectional of the knowledge card station for the interactive knowledge card system.

FIG. 5 is a plan view with a partial sectional of the knowledge card station for the interactive knowledge card system in accordance with an alternative embodiment of the invention.

FIG. 6 is a flow diagram of a process for forming individualized interactive information from the interactive knowledge card system.

FIG. 7 shows exemplary individualized interactive information provided by the interactive knowledge card system.

FIG. 8 is two plan views of the knowledge card for the interactive knowledge card system in accordance with yet another alternative embodiment of the invention.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents that operate in a similar manner to accomplish a similar purpose.

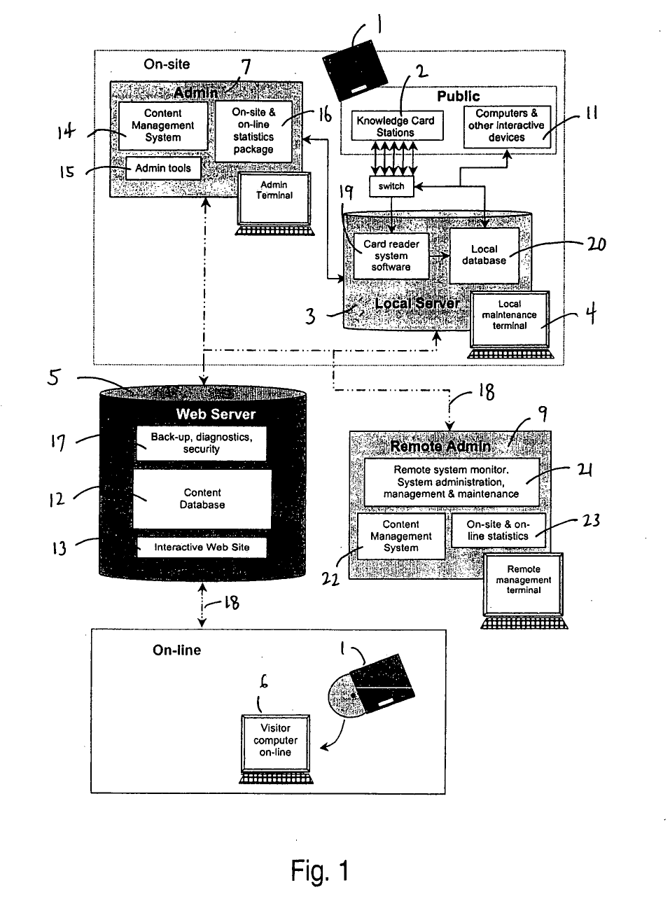

Turning to the drawings, FIG. 1 is a semi-schematic block diagram of an interactive knowledge card system in accordance with a preferred embodiment of the invention. The interactive knowledge card system is an integrated system of hardware and software components and may include a knowledge card 1, a plurality of knowledge card stations 2, a local server 3, a local maintenance computer 4, a remote web server 5, a visitor's computer 6, a local administrative computer 7, a remote administrative computer 9, and an interactive device 11. Components 3-10 each preferably comprise a processor that implements software used to control operation of that aspect of the system. The knowledge card stations 2 preferably operate under control of the local server 3, though they can also have their own processor.

The interactive knowledge card system is an interactive learning tool, a visitor-relations management system, and/or a revenue generator. The interactive knowledge card system is preferably used at a knowledge attraction which is a venue that interprets and communicates knowledge to a visitor to the venue. These knowledge attractions may be, but are not limited to, informal learning institutions, heritage tourism sites, or knowledge-oriented conferences. Examples of informal learning institutions include, but are not limited to, museums, science centers, zoos, botanical gardens, aquaria, and living-history parks. Examples of heritage tourism sites include, but are not limited to, historical sites, archeological sites, historical tourist attractions, and cultural tourist attractions. Examples of knowledge-oriented conferences include, but are not limited to, professional conferences, scientific conferences, academic conferences, and trade shows.

The interactive knowledge card system provides individualized interactive information by way of a knowledge cart based on the visitor's activities at the venue. The knowledge cart is a way of collecting information, such as tagging data in a database, and it correlates the visitor to each knowledge card station 2 the visitor visited. By correlating the visitor to each knowledge card station 2 visited, the interactive knowledge card system can provide individualized interactive information. The knowledge cart can then be later used to recall information on the visitor's computer 6, if it is connected to the Internet, at the visitor's home, school, or workplace.

Each visitor preferably receives the knowledge card 1. As the visitor enters the knowledge attraction, the visitor walks around the attraction and views the various exhibits, locations, seminars, or other sources of information. The knowledge card 1 is used to indicate their interest in obtaining more information about, for example, an exhibit, site, or conference. The user does this by passing the knowledge card 1 through the reader located at the knowledge card station 2 placed nearby. When the knowledge card 1 is read by the knowledge card station 2, a log-file is created in the local server 3. The log-file contains a unique code associated with each knowledge card 1, a unique identifier for the knowledge station 2 that read the knowledge card 1, the date the knowledge card 1 was read, and the time that the knowledge card 1 was read.

The knowledge card stations 2 are preferably installed at desired locations throughout the venue. The knowledge card stations 2 are installed, for example, according to how the venue's content is organized, both physically and pedagogically. At some venues, it may be desirable to place knowledge card stations 2 in every room or thematic area, while at other venues, the knowledge card stations 2 are placed next to significant objects or conceptual presentations. Instructions at each knowledge card station 2 indicate the knowledge that can be accessed and how to proceed. Thus, the system components can be positioned in any suitable manner without departing from the spirit and scope of the invention.

If the knowledge card 1 is successfully read by the knowledge card station 2, the knowledge card station 2 can provide further information. Computers and other interactive devices 11 may be incorporated into the interactive knowledge card system so that when a knowledge card 1 is read by a knowledge card station 2, it will activate a specific interactive device 11 which will allow visitors to interact with information stored on the database 20 or 12. The information presented on the interactive device 11 may take the form of, for example, a game, a quiz, an electronic bulletin board or other personalized activity. These interactions can be stored for later retrieval and subsequent further interaction, while still on-site or on-line after the physical visit.

Knowledge card stations 2 are connected to the local server 3. The local server is loaded with a card-reader-system software 19 and has a local database 20 for storing reader log-files. The local server 3 is coupled by a connection 18 to a remote web server 5. Connection 18 may be a connection via the Internet, a wired network, or a can also be a wireless connection. The local server 3 contains software, which buffers and backs-up code scans, providing protection for the log-files should the remote web server 5 and/or its content database 12 fail.

The remote web server 5 has an interactive content database 12, an interactive web site 13, and various back-up, diagnostic and security tools 17. The interactive web site 13 on the remote web server 5 may be accessed by visitors when they log-in via the Internet. Visitors can then use their knowledge carts to retrieve information associated with the knowledge card stations 2 that they visited and to view other information from other sources, such as knowledge card stations 2 not visited, sponsors, and other electronically available information. The remote web server 5 can be located on-site at the knowledge attraction or hosted remotely.

The local administrative processor or computer 7 is preferably connected by connection 18 to both the local server 3 and the remote web server 5. In one embodiment, the local server 3 is provided within or adjacent to the exhibit areas while the local administrative processor or computer 7 is located in an office distant from the public areas of the knowledge attraction. The local administrative computer 7 has a content management software 14, system administration tools 15, and a statistical analysis software 16. The local administrative computer 7 is used by the venue to manage and maintain the interactive knowledge card system. The content management software 14 enables the knowledge attraction to add, modify, and delete information stored on the database 20 or 12. System administration tools 15 enable staff to monitor functioning of the system both on-site and on-line. It can be used to perform software updates and to add, modify, and delete levels of access to system functions. Statistical analysis software 16 provides the knowledge attraction with data on visitor use of the system on-site and on-line. The local administrative computer 7 can be combined with the local server 3.

The remote administrative processor or computer 9 is connected by connection 18 to the local server 3. The local server 3, remote web server 5, local administrative processor or computer 7, and remote administrative processor or computer 9 are all connected together in the preferred embodiment so each can communicate with any other one. However, these need not all be connected, and they need not be connected over the same connection 18 but separate connections can instead be provided. The remote administrative computer 9 allows the entire system to be monitored, managed and maintained from a remote location, should the venue not have the capacity to do this on its own or the system's equipment provider has primary responsibility for monitoring the system. The remote administrative computer 9 includes remote monitoring software 21, content management software 22, and statistical software 23. The remote monitoring software includes software to allow the remote administrative processor or computer 9 to monitor the knowledge card stations 2, local server 3, and local database 3. The content management software 22 builds and manages the interactive content database 12, content displays, linkages, and updates. The statistical software 23 monitors usage on-site and on-line. Further, diagnostic software may be included to insure that the system is operating properly at all levels.

The interactive knowledge card system's statistical functions provide valuable information for venues. The statistical functions allow venues to track their visitors' behavior and interests, from the physical space to the virtual space. The interactive knowledge card system can register each unique knowledge card scan by the knowledge card stations 2, record both the order of visits, progress through the various exhibits (including the time spent at and between exhibits), and the time of each visit. After the site visit, by using the knowledge card code, the statistical software 23 tracks the visitor's use of the on-line interactive content database 12. It can generate a linear record of all the pages that are visited, saved, removed, revisited, or otherwise modified. The record provides the venue with data on how often visitors return to the knowledge attraction or the interactive web site 13 and how visitors' interests and behavior develop over time with each visit.

The information collected by the statistical functions can be used by a number of departments within the organization, including exhibit/conference design & planning, education & outreach, visitor services, boutique sales, membership drives, grant applications, and fundraising. For example, exhibit designers can see how visitors move through an exhibit area, which objects are chosen, ignored, or simply missed, and which are the most/least popular with visitors. This allows for remedial actions in existing exhibits and provides data for better planning of future exhibits. Visitor services departments can track members interests and provide members with additional information, links and services, based upon their choices. Visitors who access the interactive web site 13 can voluntarily provide demographic information, such as name, email address, zip code, occupation, education, and other pertinent information. The information provided by the visitor aids the venue in understanding its visitors, communicating with those visitors, and establishing a long-term relationship.

Additional data received through the voluntary registration fields at the log-in further enrich the venue's understanding of their visitors' interests and behavior. It also allows the venue to communicate directly with visitors, keeping them abreast of activities and events which may meet their interests, such as new exhibits, traveling exhibitions, seminars, field trips, fundraising campaigns, and other similar occurrences.

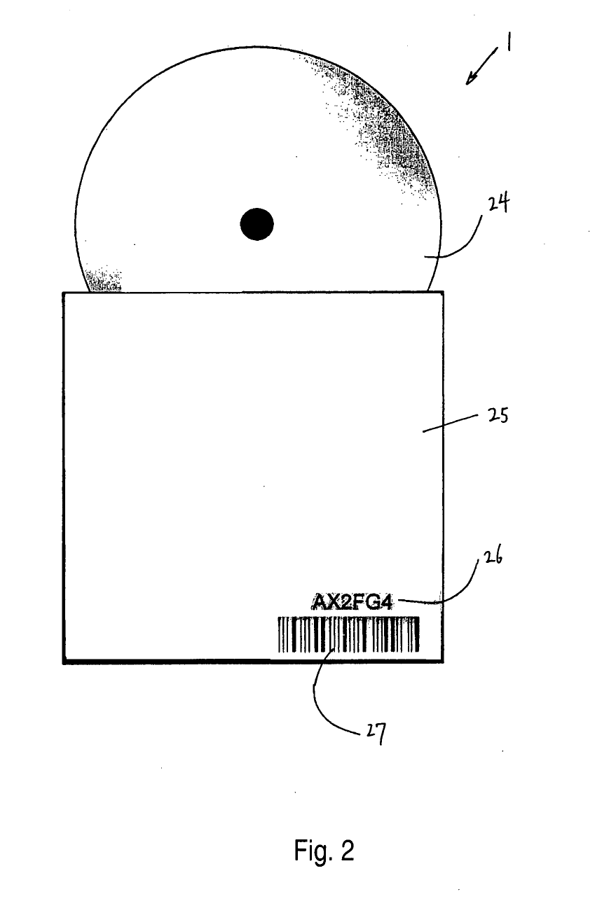

Referring to FIG. 2, the knowledge card 1 is shown in accordance with an embodiment of the invention. The knowledge card 1 preferably includes a compact storage medium 24 packaged in a sleeve 25 or other holder, on which is printed or affixed a unique, machine-readable code 27 and a corresponding human-readable alphanumeric user code 26. The knowledge card 1 can be, or form a part of, an informational brochure or an admission ticket. The compact storage medium 24 may contain multi-media content reinforcing the content or messages of the venue. The compact storage medium 24 may be, but is not limited to, a CD, a DVD, a USB drive, memory stick, or another computer-readable media. The machine-readable code 27 may be, but is not limited to, a bar-code, a magnetic stripe, a RFID tag, a biometric tag, a smart-card communication technology-based code, or another code. If economically feasible, the code 27 can be provided compact storage medium 24 while the card 1 is being read or shortly thereafter.

Away from the venue, visitors can insert the compact storage medium 24 that accompanies the knowledge card 1 into their computer 6. Upon accessing the compact storage medium 24, visitors can access a variety of content on the compact storage medium 24. The content can be a multi-media program, which summarizes the content or messages of the venue, electronic catalogs about the venue, links to information from sponsors, and other electronic data. If their computers 6 are connected to the Internet, the visitors can access their personal knowledge cart at the interactive web site 13 by entering the alphanumeric user code 26 printed on the holder 25 of the knowledge card 1 or saved to the compact storage medium 24 of the knowledge card 1.

When visitors log in with their user codes 26, the interactive content database 12 retrieves all of the information associated with the particular knowledge stations 2 that were scanned during the physical visit to the venue and presents them by way of the knowledge cart. Thus, each visitor's knowledge cart is unique and may be personalized. The information presented at each knowledge station 2 is stored in the database 12 as content files. Thus, one or more content files store the information associated with each of the knowledge card stations 2. The content files are electronically linked with the user code 27 so that the appropriate files or objects related to each knowledge station 2 scanned during the physical visit can be presented to the visitor later as the knowledge cart. The selections and preferences made by the user while online are also linked to the user code 27.

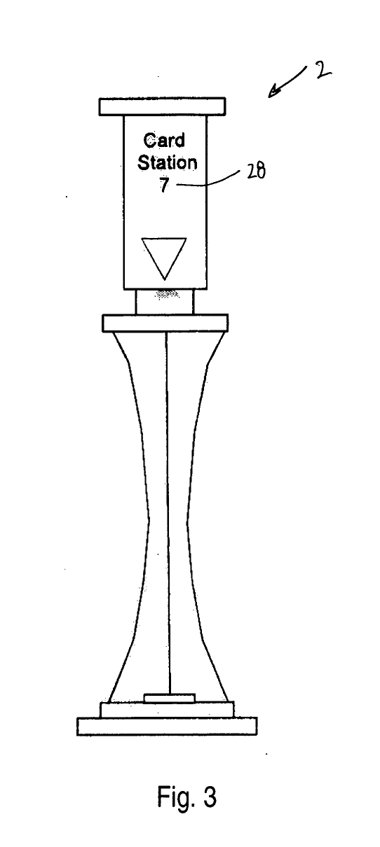

Referring to FIG. 3, a plan view of the knowledge card station 2 is shown. Each knowledge card station 2 has a unique identification number or station identifier 28 which is preferably displayed on the station 2. The exterior design of the knowledge card station 2 can be modified as necessary to conform to the overall design of the knowledge attraction as long as it can accommodate the required internal devices. The knowledge card station 2 can be passive and simply register user codes 26. In another embodiment, the knowledge card station 2 can be interactive by way of the interactive device 11.

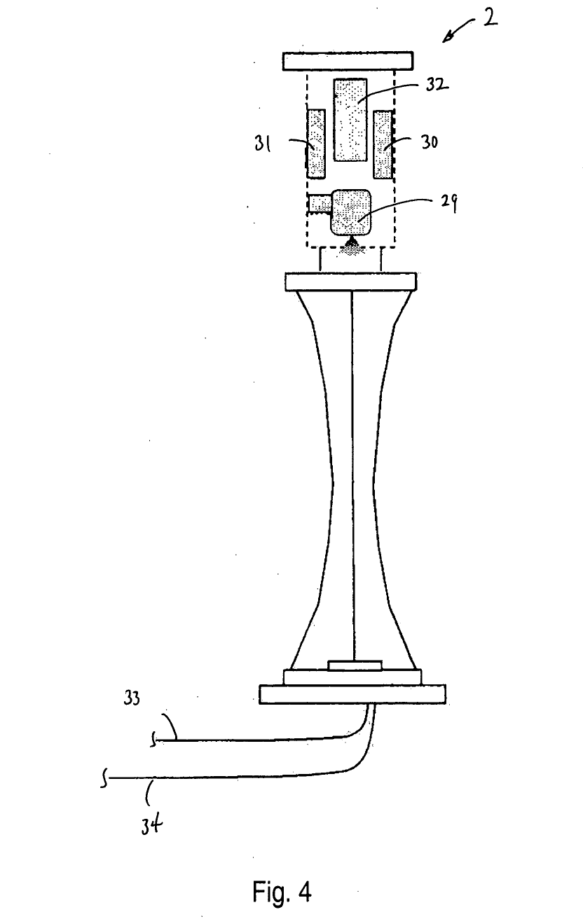

Referring to FIG. 4, a plan view with a partial sectional of the knowledge card station 2 is shown. The knowledge card station 2 includes a code reader 29, a signal converter 30, an amplifier 31, a power supply 32, a power connection 33, and a network connection 34 to the local server. The code reader 29 is connected via the network connection 34 to the local database 20 on the local server 3. The visitor passes the knowledge card 1 under the reader 29, as directed by the arrow in FIG. 3. Although an arrow is used in FIG. 3, the visitor can also be directed to pass the knowledge card 1 under the reader 29 by, for example, explanatory text or an image such as a depiction of a finger. The signal converter 30 and the amplifier 31 may be needed depending on the distance between the knowledge card station 2 and the local server 3. If the signal converter 30 or the amplifier 31 is required, then they are connected to the card reader 29.

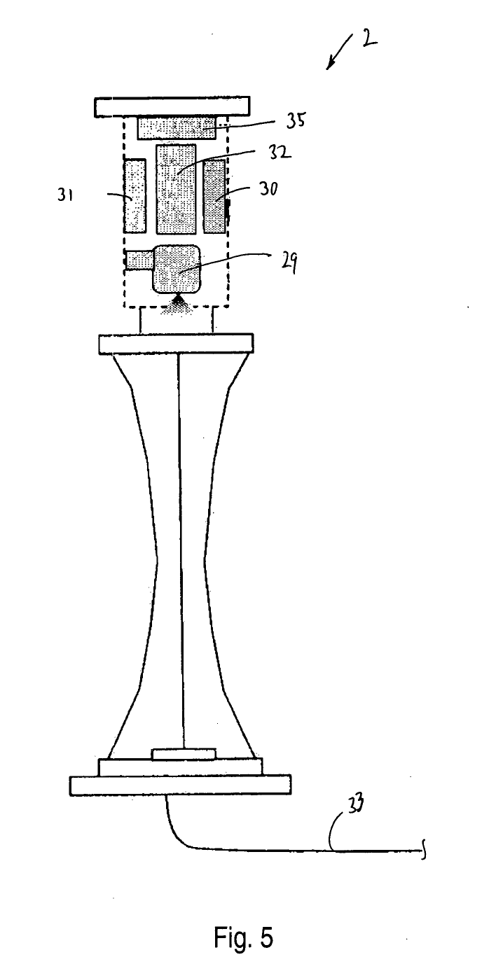

Referring to FIG. 5, a plan view with a partial sectional of the knowledge card station is shown. The knowledge card station 2 includes a code reader 29, a signal converter 30, an amplifier 31, a power supply 32, a power connection 33, and a wireless connection 35 to the local server. The code reader 29 is connected via the wireless connection 35 to the local database 20 on the local server 3. The wireless connection may be, but not limited to, a W-LAN or a Bluetooth antenna. The signal converter 30 and the amplifier 31 may also be needed. If the signal converter 30 or the amplifier 31 is required, then they are connected to the card reader 29.

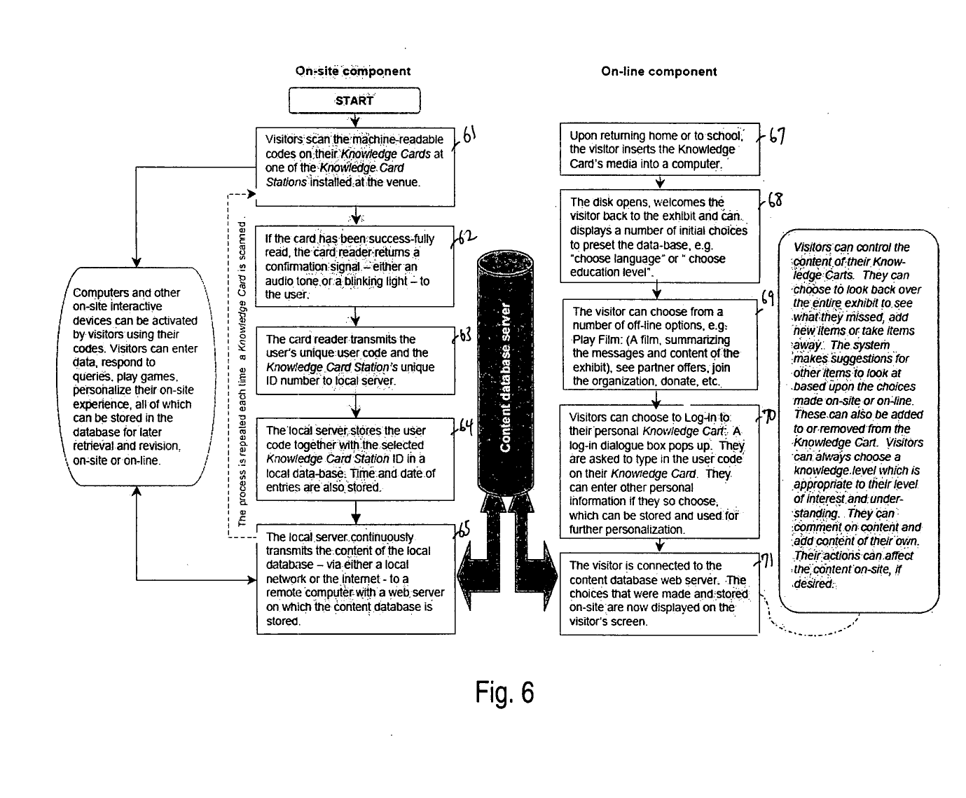

Referring to FIG. 6, a flow diagram shows a process for forming individualized interactive information from the interactive knowledge card system. Starting at step 61, the visitor uses the knowledge card 1 to indicate their interest in more information about, for example, an exhibit, site or conference. Here, the user passes the machine-readable code 27 on the knowledge card 1 under the appropriate knowledge card station's code reader 29 so that the code is scanned. At step 62, if the code has been successfully read from the knowledge card 1, the card reader 29 returns a confirmation signal which may be audio, visual or both. The card reader 29 then transmits the card's unique code 27 and the knowledge card station's unique station identifier 28 to the local server 3, step 63.

Next, in step 64, the local server 3 automatically receives and stores in the local server's database 20 each card's unique code 27, along with the station identifier 28 of the chosen knowledge card station 2, and the date and time of each scan. The server has a buffer so that it can take a virtually unlimited number of simultaneous readings. The local server 3 creates the visitor's log-file which includes the card's unique code 29, knowledge card station identifier 28, and date and time of card scan. Then, in step 65, the visitor's log-file on the local database 20 is uploaded, preferably immediately, to the database 12 on the remote web server 5, where it is stored. The log-file can also be stored at the local database 20 for backup. When the server 12 creates one or more log-files, the knowledge cart can correlate the content files associated with each knowledge card station identifiers 28 to a particular card's unique code 29.

If other interactive devices 11 are part of the interactive knowledge card system, the card scan could also be utilized to activate the interactive device 11 associated with the station identifier 28. For instance, the card scan can activate a multimedia presentation, provide access to more information, a quiz, or a game on the interactive device 11. The results of the quiz or game can be stored on the database 12 or 20 for later access. The card scan can also solicit the visitor to enter comments which can be presented to the public on displays at the exhibit or on-line to other visitors who have logged in to the interactive web site 13.

If the visitor is accessing the content database 5 away from the venue, the visitor inserts the compact storage medium 24 that can accompany the knowledge card 1 into the user's computer 6, step 67. Upon accessing the compact storage medium 24, the visitor may be presented with several initial choices, step 68. The choices can include preferences on how information will be conveyed, such as the language in which the information is provided or the level of detail which corresponds to the visitor's educational background. At step 69, the visitor may click on a number of icons to play the multi-media program which can summarize the content or messages of the venue, view offers from sponsors, learn how to donate money to the venue, and/or other off-line content. Alternately, at step 70, if the visitor is accessing the compact storage medium 24 on a computer with access to the Internet, the visitor may click on another icon or link which takes the visitor to a log-in page. Next, at step 71, by entering the alphanumeric user code 26 which may be included with the knowledge card 1, the visitor gains access to the visitor's personal knowledge cart. The log-in may also contain a number of other fields—such as name, email address, certain demographic information—which are not required but may enable visitors to further personalize their knowledge carts and to communicate with the venue and with others who use the interactive web site 13.

When the visitor logs in with the alphanumeric user code 26, the server retrieves from the database 12 all of the content files that are associated with the knowledge card stations 2 that were scanned during the visitor's physical visit to the venue which were tagged by the user during a prior online session. The information is then presented to the visitor. Each visitor's knowledge cart can then be further individualized by adding to the information presented or taking away information no longer wanted.

There is a pedagogical relationship between the knowledge cards 1 and the knowledge carts. The interactive knowledge card system provides practical and pedagogical motivators for the visitors to check the venue's website following a visit to the venue. The interactive knowledge card system provides an easy way for visitors to get to the interactive web site and their personalized knowledge carts. The visitor only needs to use a clickable link to the interactive site contained on the compact storage medium 24. The clickable link can be in the form of an icon which takes the visitor to the log-in where the visitor enters the user code 26. Thus, the visitor does not have to remember a URL or even type it in. Also, visitors use their knowledge cards 1 actively on-site to indicate their interest in various parts of a venue. In addition, the visitor can be offered an incentive at the physical venue, such as discounts for future visits or other products and services that are retrievable online. Thus, they may have a stake, an interest, and a motivation in using the knowledge card 1 again when they leave the site to see the results of their activities as collected by their knowledge carts.

The compact storage medium 24 may also contain attractive and entertaining content about a subject in which the visitor is interested to still further motivate the user to access the compact storage medium 24. Further, visitors know that they have full control over the content collected by their knowledge cart. It is filled with their choices so that their knowledge cart has just as much or as little content as they want to have. Thus, the interactive knowledge card system initially presents the visitor with only the choices that the visitor made at the venue, but then offers many features, which allow the visitor to explore further.

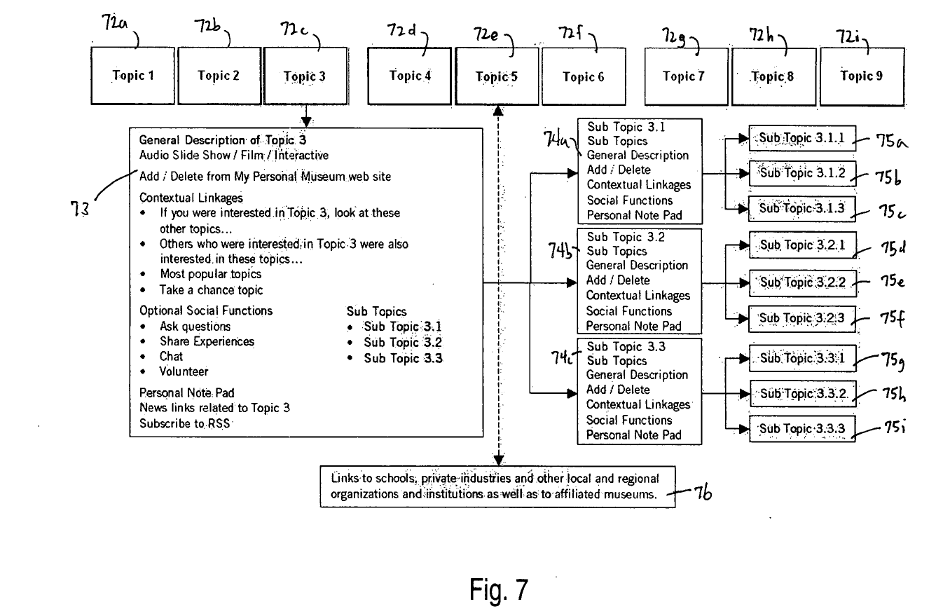

Referring to FIG. 7, exemplary individualized interactive information provided by the interactive knowledge card system is shown in accordance with an embodiment of the invention. The system collects information 72a-72c associated with the knowledge card station 2 that the visitor visited, i.e. it builds the knowledge cart. Then the information is presented to the visitor in exemplary display 73. In the display 73, the interactive knowledge card system can also offer visitors suggestions for additional content that is related to the choices they have made, both on-site and on-line, for example: “If you are interested in x then you should also look at y and z.” Visitors can also be presented with choices that other people have made. For example, “Others who were interested in X were also interested in Y and Z,” and “Look at the most popular topics.” That information can be determined by a statistical evaluation of user's interest while at the physical or on-line site or by an administrator. All of these contextual and relational functions have the purpose of motivating visitors to explore beyond their initial choices, while allowing them to accept or decline the suggestion. The knowledge attraction can also offer a random topic that may interest the visitor.

The interactive knowledge card system also offers a number of social communication functions, all of which can be monitored through the administrative processor or computer 7 or 9. The social communication functions include visitors sending in questions for experts from the venue. Visitors may also publish comments, comment on other's comments or publish their own experiences and content, which are viewed by other visitors in specifically assigned spaces on the interactive web site 13. Comments and messages may be exchanged via the interactive web site 13 between visitors at computer terminals at the venue and visitors on-line at remote locations. Moreover, visitors can send electronic postcards with pictures and text messages. Later, after leaving the venue, visitors can continue to work on-line with the activities they initiated at the system's computer terminals while they were at the venue.

Through display 73, visitors can also contact the knowledge attraction staff, view the knowledge attraction calendar of upcoming events, view news, enter contests, download a podcast, join a club, make donations, use publishing tools to edit their personalized content, create lesson plans for teaching others, and conduct other electronic activities through their knowledge cart. The knowledge attraction can present special offers, messages from corporate sponsors, news, upcoming events, and other electronic information through the knowledge cart. Visitors can also subscribe to “Really Simple Syndication” or RSS feeds to be notified when there are updates to topics 72a-72i in which they are interested.

Content may be layered to be accessible for different ages, skills, intelligences, and levels of knowledge. For example, as shown in the embodiment of FIG. 7, for a museum exhibit, the database 20 may display an initial level 73 that is an introduction or summary presented in a style and complexity suitable for, as an example, elementary school students. Here, the user has selected to view Topic 3 of the information previously selected at the museum. The user can select one of the subtopics from display 73, which results in the display of that sub-topic of information at displays 74a-74c. Display 74a, 74b, or 74c may be a more detailed presentation of various sub-topics, appropriate for, as an example, junior high school students, while displays 75a-75i could present even more detailed information, which would require, for example, at least a high school or university background. Levels may be changed when the visitor so desires. Visitors can easily find an appropriate level, and then save that subject at the chosen level, so that when they return to the collection provided by their knowledge carts at a later time, they do not have to repeat the search for the appropriate level of information.

The knowledge carts are dynamic and interactive. Visitors have control over the content provided and may add or remove files 72a-72i according to their own interests and at their own pace and schedule. Visitors can view all of the venue's content in virtual form and browse the database for content 72a-72i that they may have missed or chosen to ignore during their physical visit to the venue. For example, visitors may be presented with a map of the knowledge attraction and can revisit any portion of the knowledge attraction by clicking on the map.

Suggestions for additional content may be useful, especially in venues with many objects or large areas. The interactive knowledge card system also shows the relationships between objects and ideas at opposite ends of an exhibit hall or in distant parts of a site. The interactive knowledge card system provides visitors with a broader context by providing links to additional information from the venue or from other approved linkages 76, based upon each visitor's unique choices.

Information from many physically discreet venues, such as separate museums, conferences, historical sites, or other similar venues, are preferably linked together with the interactive knowledge card system. For example, knowledge card stations 2 may be installed in a number of different museums. Then, the visitor preferably uses the same knowledge card 1 in each museum to access the information of all the museums in the same personal and interactive manner as described above.

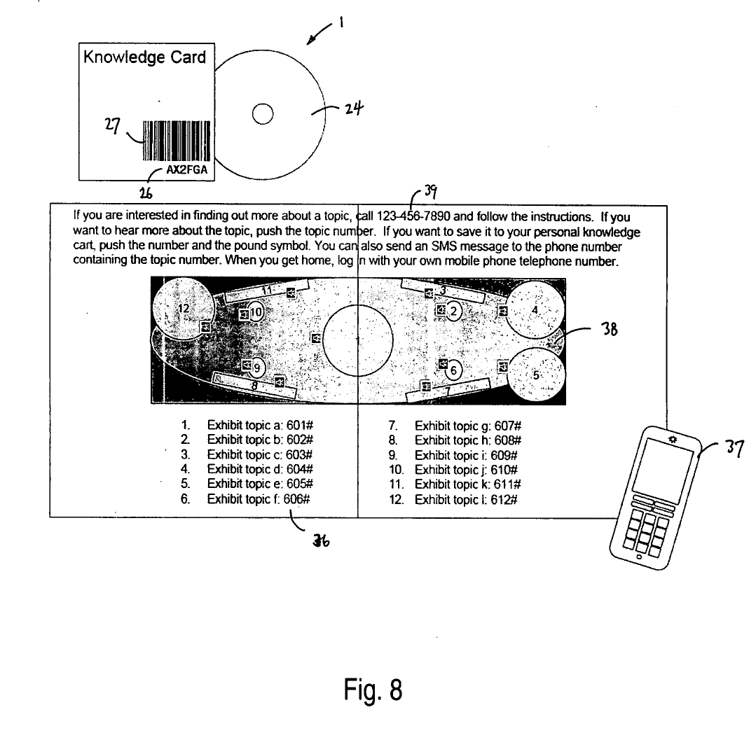

Referring to FIG. 8, the knowledge card 1 in accordance with another embodiment of the present invention is shown. The knowledge card 1 includes a unique bar code 27, unique alphanumeric user code 26, computer-readable medium 24, site map 38, SMS number 39, and area identifiers 36. The present embodiment of the invention is best suited for venues that cover large outdoor areas, such as archeological sites, living history parks, or other similar large-area sites. At these locations, knowledge card readers 2 and local area networks are not well-suited and instead, the interactive knowledge card system is implemented using a mobile telephone 37 or similar device such as a data transmitter, responder, personal digital assistant (PDA), or email device. Specific objects, places, or other points of interest are marked on the site map 38, which is preferably printed on the knowledge card 1.

Each point of interest is “coded” with the short numeric code or area identifier 36. To indicate their interest in a particular point of interest, visitors use their mobile telephone 37. In one embodiment, the visitor calls a specific telephone number 39 which provides a connection to the content database 12 or 20. Upon hearing a voice cue, the visitor enters the area identifier 36 of the area in which the visitor is interested on the keypad of the mobile telephone 37. For instance, if the user is interested in the exhibit at area 12 of the map 38, the user could enter “12” or area identifier “612” on the keypad. Once the area identifier 36 is entered, a message to the database 12 or 20 activates an audio description corresponding to the entered area identifier 36. If the visitor wants to “save” the information related to the entered area identifier 36 to the knowledge cart, the visitor pushes a predetermined key, such as the “#” key, on the keypad of the mobile telephone 37 to send a log file to the database 12 or 20. The log file contains the area identifier 36 as indicated by the entry on the keypad, the visitor's mobile telephone number, and time and date of the entry. Then the knowledge cart collects information associated with the entered area identifier 36 with the visitor's mobile telephone number.

Thus the log file provides similar information to the database as when the visitor scans the knowledge card 1 in the embodiment of FIG. 1. One difference is that instead of logging the machine-readable code 27 of the knowledge card 1, the visitor's mobile telephone number is logged and then used in the log-in process to access the database 12 or 20. In another embodiment, the mobile telephone's text-messaging system is used. The visitor sends a message containing the appropriate area identifier 36 to the SMS number 39, which is indicated on the knowledge card 1. Log files are sent from the visitor's mobile telephone operator to the interactive knowledge card system's remote web server 5 where they are saved onto the content database 20 as described previously. The visitor also receives text or audio-visual content on-site from the remote web server 5 in the form of an audio, SMS, or MMS message on their mobile telephone 37. If the visitor wants to access the interactive knowledge card system on-line, the visitor uses the cell phone telephone number as the user code 26 at the log-in.

Another advantage of the interactive knowledge card system is that it provides a system for revenue generation. The interactive knowledge card system provides a platform for sponsors that may be valuable to knowledge attractions. A number of trends make sponsorships a critical to the success of venues in achieving their goals: audiences are increasing, many attractions are offering free admission or are lowering their admission prices to be competitive, and the demands for services, such as educational, experiential, and social, are increasing.

The system provides sponsors with the traditional benefits of a sponsorship platform including brand exposure and direct mailings. “Advertising space” for sponsors' logos can be sold on the knowledge card 1 by utilizing, for example, a space on the CD/DVD sleeve 25, a label on the disc itself, and on a lanyard from which the disc hangs around the visitor's neck. Additional advertising space may be found electronically on the CD/DVD and on-line. Sponsors can appear by way of each visitor's knowledge cart, acting as knowledge partners by providing more information about each visitor's interest. Links collected by the knowledge cart to specially created pages on the sponsor's own site can further the relationships between the sponsors and the visitors, allowing sponsors to communicate directly with the visitors with more content, special offers, campaigns, and other similar communications. In return, sponsors may be provided with the results of such communications.

As apparent from the above description, the present invention provides an interactive knowledge card system that provides a number of advantages which improves pedagogical, audience, and financial goals for knowledge attractions. The interactive knowledge card system allows knowledge attractions to become more accessible to their visitors by providing visitors with continued access to information and the ability to communicate with the venue after leaving the site. Knowledge attractions are able to collect more comprehensive data on visitors' behavior and interests, yielding significant benefits for planning, visitor services, fundraising, and other key organizational support functions. The interactive knowledge card system helps knowledge attractions raise money by providing a platform on which to build deep and long-term relationships with their visitors, satisfy the educational and accessibility goals of their public funding agencies and granting organizations, and meet their sponsors' needs for brand exposure and measurable results.

The foregoing description and drawings should be considered as illustrative only of the principles of the invention. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

We claim:

1. An interactive knowledge card system comprising:
a card having a user identification;
a plurality of card stations, each of said plurality of card stations having a station identifier and an user identification reader to read the user identification on said card;
a server in communication with said plurality of card stations, said server receiving the read user identification and the station identifier from said user identification reader and associating the read user identification with the received station identifier; and
a database in communication with said server, said database storing exhibit information associated with each said station identifier, said database storing the read user identification and associated station identifier;
wherein said server is accessible by the user, retrieves the exhibit information associated with each station identifier associated with the user identification, and displays the retrieved exhibit information.

2. The interactive knowledge card system according to claim 1, wherein said card further comprises a compact storage medium.

3. The interactive knowledge card system according to claim 1, wherein said user identification is a bar code and said user identification mark reader is a bar code reader.

4. The interactive knowledge card system according to claim 1, wherein the plurality of card stations are disposed at a venue.

5. The interactive knowledge card system according to claim 1, further comprising an interactive device coupled to said card station for presenting information to the user.

6. The interactive knowledge card system according to claim 5, wherein said exhibit information associated with a station identifier is provided on said interactive device when said identification mark reader reads said identification mark.

7. The interactive knowledge card system according to claim 1, wherein said server is a local server and further comprising a remote web server having a remote database in communication with said local server and said at least one database.

8. The interactive knowledge card system according to claim 1, wherein said database is accessible over the Internet.

9. The interactive knowledge card system according to claim 1, further comprising an administrative computer for managing the interactive knowledge system and for providing statistical analysis.

10. An interactive knowledge card system for use at a location having a plurality of areas, each area associated with information, the system comprising:
an area identifier for each of said plurality of areas;
a mobile telephone having a mobile telephone number;
a server receiving the mobile telephone number and the area identifier from said mobile telephone, said server associating the mobile telephone number with the area identifier; and
a database in communication with said server, said database storing exhibit information associated with each said area identifier, said database storing the mobile telephone number and associated area identifier;
wherein said server is accessible by the user, retrieves the exhibit information associated with each area identifier associated with the mobile telephone number and displays the retrieved exhibit information.

11. The interactive knowledge card system according to claim 10, further comprising a card having a user identification, said card listing said area identifiers.

12. The interactive knowledge card system according to claim 11, wherein said card further comprises a compact storage medium.

13. The interactive knowledge card system according to claim 10, wherein said server is a remote web server.

14. The interactive knowledge card system according to claim 10, wherein said database is accessible over the Internet.

15. The interactive knowledge card system according to claim 10, further comprising an administrative computer for managing the interactive knowledge system and for providing statistical analysis.

16. A method for providing interactive and individualized information, the method comprising:
providing a user with a card having an user identification;
disposing a plurality of card stations throughout a location, each of the plurality of card stations having an user identification reader to read the user identification on the card;
assigning a station identifier for each of the plurality of card stations;
coupling a server in communication with the plurality of card stations;
storing exhibit information associated with each station identifier on at least one database in communication with the server;
storing on the database the user identification and station identifier of the user identification reader that read the user identification;
correlating the user identification with the exhibit information associated with the station identifier of the user identification reader that read the user identification; and
providing the exhibit information associated with each station identifier whose user identification reader that read the user identification.

17. The method according to claim 16, wherein the card further comprises a compact storage medium.

18. The method according to claim 16, wherein the identification mark is a bar code and the user identification reader is a bar code reader.

19. The method according to claim 16, further comprising the step of:
coupling an interactive device to a card station; and
providing exhibit information associated with the station identifier on the interactive device when the user identification reader reads the user identification.

20. The method according to claim 16, wherein the server is a local server and further comprising a remote web server having a remote database in communication with the local server and the at least one database.

21. The method according to claim 16, further comprising the step of coupling an administrative computer to the server for managing the interactive knowledge system and for providing statistical analysis.

22. The method according to claim 16, further comprising the step of coupling the database to the Internet so that the database is accessible over the Internet.
